(19) United States
(12) Patent Application Publication
(10) Pub. No.: US 2002/0015504 A1
(43) Pub. Date: Feb. 7, 2002

(54) Mixing apparatus with recording/reproducing function

(76) Inventors: Akito Kohno, Hamamatsu-shi (JP); Takahisa Kageyama, Hamamatsu-shi (JP)

Correspondence Address: David L. Fehrman, Morrison & Foerster LLP, 35th Floor, 555 W. 5th Street, Los Angeles, CA, 90013, US

(21) Appl. No.: 09/912,873

(22) Filed: Jul. 25, 2001

(30) Foreign Application Priority Data
Aug. 4, 2000 (JP) 2000-236483

(51) Int. Cl. H04B 1/00; H02B 1/00

(52) U.S. Cl. 381/119; 381/123; 369/4

(57) ABSTRACT

A recording/reproducing mixer comprises a recording/reproducing device that records and/or reproduces a plurality of audio signals in/from a plurality of tracks, a track selector that selects a track of said recording/reproducing device, a reader that reads audio signals of the selected track of said recording/reproducing device, a mixing device that mixes the read audio signals, a designator that designates a listening mode, and an output controller that outputs the read audio signals bypassing said mixing device when the listening mode is designated, and outputs the read audio signals via said mixing device when the listening mode is not designated.

This application is based on Japanese Patent Application 2000-36483, filed on Aug. 4, 2000, the entire contents of which are incorporated herein by reference.

### BACKGROUND OF THE INVENTION

a) Field of the Invention

The present invention relates to a mixing apparatus for mixing audio signals output from a plurality of electronic musical instruments and audio apparatus, and more particularly to a mixing apparatus with a recording/reproducing function.

b) Description of the Related Art

A mixing apparatus with a recording/reproducing function has been recently proposed. Such a mixing apparatus has a digital mixer and an HD recorder. The digital mixer digitally mixes analog or digital audio signals input from electronic musical instruments, microphones and the like. The HD recorder uses a hard disk drive (HDD) as a recording device and can record at the same time audio signals of a plurality of channels in a plurality of tracks of a hard disk.

The digital mixer executes processes such as equalizing, volume adjustment and effect addition, for audio signals input from each of a plurality of channels, and thereafter mixes the channels and outputs sounds.

The HD recorder has a plurality of tracks, can input a plurality of audio signals to record them in each track, and in addition, can reproduce a plurality of audio signals recorded beforehand and output them to a predetermined destination.

A conventional mixing apparatus with a recording/reproducing function can process a reproduction output of the HD recorder as an input to the digital mixer and also can process an output of the digital mixer as an input to the HD recorder.

In listening sounds of audio signals recorded in one track of the HD recorder of a conventional digital mixer with a recording/reproducing function, it is necessary to first assign each track to one channel (ch) of the digital mixer. Sounds are listened by utilizing a SOLO function (a function of listening an arbitrary channel) provided to the digital mixer.

The SOLO function is a function allowing a user to listen to a desired channel during mixing without lowering the faders of other channels. The SOLO function is also a function allowing a user to output sounds of a desired channel only from a head phone or monitor speaker, while the state of the subject channel is maintained.

The SOLO function includes a “LAST SOLO” function allowing a user to monitor only the last selected channel and a “MIX SOLO” function allowing a user to add and synthesize selected channels.

In using this SOLO function, after audio signals are subjected to various processes by the digital mixer, such as equalizing, volume adjustment and effect addition, they are output to SOLO buses. Therefore, in order to listen sounds of audio signals (in a raw state) not subjected to various processes such as equalizing, volume adjustment and effect addition, it is necessary to cancel the settings of equalizing, volume adjustment, effect addition and the like.

Moreover, with a conventional digital mixer with a recording/reproducing function, if the start position of listening is to be recovered after listening by using the SOLO function, it is necessary for a user to manually search the start position.

### SUMMARY OF THE INVENTION

An object of the present invention is to provide a digital mixer with a recording/reproducing function capable of listening sounds of sounds signals not subjected to various processes, with a simple operation.

Another object of the present invention is to provide a digital mixer with a recording/reproducing function capable of recovering the listening start position after listening, with a simple operation.

According to an aspect of the present invention, there is provided a recording/reproducing mixer comprises a recording/reproducing device that records and/or reproduces a plurality of audio signals in/from a plurality of tracks, a track selector that selects a track of said recording/reproducing device, a reader that reads audio signals of the selected track of said recording/reproducing device, a mixing device that mixes the read audio signals, a designator that designates a listening mode, and an output controller that outputs the read audio signals bypassing said mixing device when the listening mode is designated, and outputs the read audio signals via said mixing device when the listening mode is not designated.

As above, sounds of raw audio signals not subjected to various processes can be listened with a simple operation.

### BRIEF DESCRIPTION OF THE DRAWINGS

FIG. 1 is a block diagram showing the fundamental structure of a digital mixer 1 with a reproducing/recording function according to an embodiment of the invention.

FIG. 2 is a block diagram showing the functions of a DSP 25 shown in FIG. 1.

FIG. 3 is a schematic diagram showing an example of a front panel 2 of the digital mixer 1 with a reproducing/recording function shown in FIG. 1.

FIG. 4 is an enlarged schematic diagram showing an FL display 23b and its nearby area shown in FIG. 3.

FIGS. 5A and 5B are block diagrams illustrating the fundamental functions of the embodiment.

FIG. 6 is a connection diagram of a mixer input channel of the digital mixer with a reproducing/recording function of the embodiment.

FIG. 7 is a connection diagram of a recorder input channel of the digital mixer with a reproducing/recording function of the embodiment.

FIG. 8 is a connection diagram of an output selector of the digital mixer with a reproducing/recording function of the embodiment.

FIG. 9 is a flow chart illustrating a listening mode process to be executed by a CPU 16 shown in FIG. 1.

FIG. 10 is a diagram showing storage areas of a RAM 14 shown in FIG. 1.

### DETAILED DESCRIPTION OF THE PREFERRED EMBODIMENTS

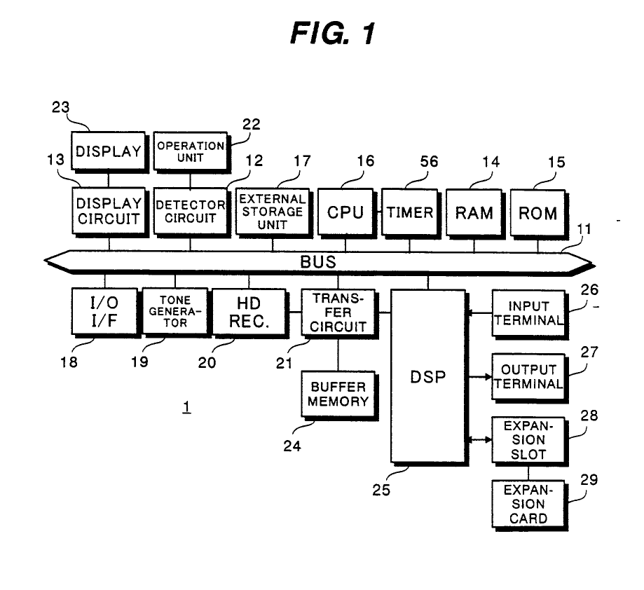

FIG. 1 is a block diagram showing the fundamental structure of a digital mixer 1 with a reproducing/recording function according to an embodiment of the invention.

A bus 11 connects a detector circuit 12, a display circuit 13, a RAM 14, a ROM 15, a CPU 16, an external storage unit 17, an input/output (I/O) interface 18, a timer 56, a tone signal generator circuit 19, a hard disk recorder (HD recorder) 20, a transfer circuit 21 and a digital sound processor (DSP) 25.

A user can enter settings of equalizing, effect addition, volume adjustment, and mixing, and can input and select various parameters and presettings, by using a plurality of operation units (input units) 22 connected to the detector circuit 12. The operation unit 22 may be any device capable of outputting signals corresponding to user inputs, such as a jog shuttle, a rotary encoder, a fader, a slider, a mouse, a keyboard, a musical keyboard, a joy stick, and a switch. In this embodiment a plurality of operation units are connected.

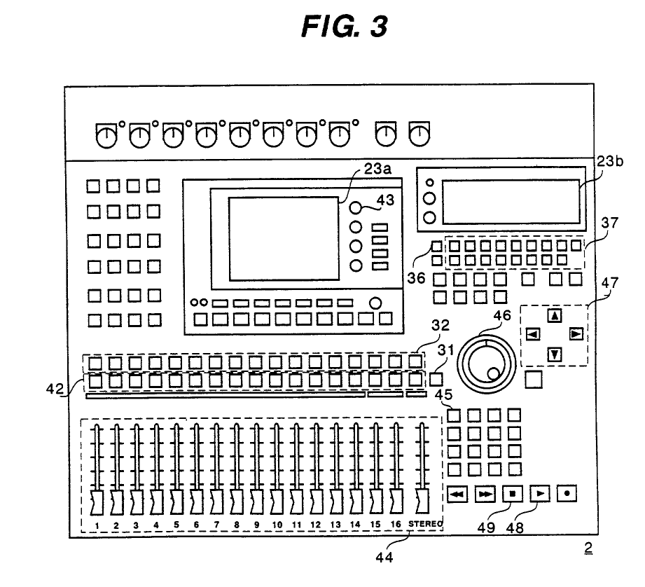

The display circuit 13 is connected to a display 23 and can display various information on the display 131, such as settings of equalizing, effect addition and volume adjustment of each channel. The display 23 is made of a liquid crystal display (LCD), light emitting diodes (LED's) or the like. Other devices capable of displaying various information may also be used. In this embodiment, as will be later described with FIG. 3, two displays are connected, one being a mixing process LCD display 23a and the other being an HDD recorder FL display 23b.

RAM 14 has flags, registers, buffers and working areas for CPU 16 for storing various data.

ROM 15 can store presetting data, various parameters, control programs and other data. The program and the like are not required to be stored duplicately in the external storage unit 17. CPU 16 performs calculations or controls in accordance with the program and the like stored in ROM 15 or the external storage unit 17.

The timer 56 is connected to CPU 16 and the bus 11 and supplies CPU 16 with a main clock signal, an interrupt timing and the like.

The external storage unit 17 includes an interface for an external storage unit andiskonnected via the interface to the bus 11. The external storage unit 17 may be a CD-RW drive, a semiconductor memory such as a flash memory, a floppy disk drive (FDD), a hard disk drive (HDD), a magneto optical disk (MO) drive, a CD-ROM (compact disk read-only memory) drive, or a DVD (Digital Versatile Disk) drive. The external storage unit 17 may be omitted.

In this embodiment, a CD-RW drive is connected as the external storage unit 17. The CD-RW drive can store various information. By using the CD-RW drive, a user may acquire audio signals recorded in the HD recorder 20 from a plurality of tracks to use stereo digital audio signals and form a music CD.

The I/O interface 18 is used for connecting an electronic musical instrument, another audio apparatus, a computer, an expanded HDD or the like. In this case, as the I/O interface 18, a general purpose interface is used such as a MIDI interface, a SCSI (Small Computer System Interface), RS-232C, USB (Universal Serial Bus), and IEEE 1394 (I triple E's 1394). In this embodiment, a plurality of I/O interfaces 18 are used.

The tone signal generator circuit 19 generates tone signals in accordance with supplied MIDI signals or the like, and supplies the generated tone signals to DSP 25 or the like via the bus 11.

The tone signal generator circuit 19 may be of any type, such as a waveform memory type, an FM type, a physical model type, a harmonics synthesis type, a formant synthesis type, and an analog synthesizer type having a VCO (Voltage Controlled Oscillator)+VCF (Voltage Controlled Filter)+VCA (Voltage Controlled Amplifier).

The tone signal generator circuit 19 is not limited only to those made of hardware, but may be realized by a DSP (Digital Signal Processor) and a microprogram, by a CPU and a software program, or by a sound card.

One tone generator circuit may be used time divisionally to form a plurality of sound producing channels, or a plurality of tone signal generator circuits may be used to form a plurality of sound producing channels by using one tone signal generator circuit per one sound producing channel.

The HD recorder 20 is made of a hard disk drive (HDD). The HD recorder 20 can record digital audio signals independently or at the same time into a plurality of tracks (in this embodiment, 16 tracks), for example, at a resolution of 16 bits (or 24 bits) and 44.1 kHz (or 48 kHz).

The transfer circuit 21 is connected to a buffer memory 24 and transfers data (audio signals) between the HD recorder 20 and buffer memory 24 and between DSP 25 and buffer memory 24, under the control of CPU 16.

For example, when audio signals are recorded in a desired track of the HD recorder 20, the transfer circuit 21 receives digital data (audio signals) of one sample from DSP 25 at each predetermined sampling period (e.g., 44.1 kHz), and writes it into the buffer memory 24. The transfer circuit 21 repeats the write operation to the buffer memory 24, and when digital data of one cluster is collected in the buffer memory 24, the digital data is sequentially written in the track storage areas thereof. During the data writing to the HD recorder 20, the transfer circuit 21 continues to read data from DSP 25 and write it to the buffer memory 24. With the above operations being repeated, data recording is performed.

When audio signals in a desired track of the HD recorder 20 are reproduced, the transfer circuit 21 reads the audio data in the top two clusters of the track storage area of the HD recorder 20 and stores it in the buffer memory 24. Thereafter, the transfer circuit supplies digital data of one sample to DSP 25 at each predetermined sampling period. Each time an empty area of one cluster is formed in the buffer memory 24, the transfer circuit 21 sequentially reads the data of one cluster from the track storage area of the HD recorder 20. With the above operations being repeated, data reproducing is performed.

Digital audio signals to be input to the HD recorder DSP 25 via the input terminals 26 and transfer circuit 21 are subjected to various processes including a mixing process by DSP 25, and the processed digital signals are output to the output terminals. An expansion slot 28 is connected to increase the numbers of input and output terminals. An expansion card 29 for increasing the number of input and output terminals can be inserted into an expansion slot 28.

Each input terminal 26 has an AD converter (ADC) for converting analog audio signals into digital audio signals, and each output terminal 27 has a DA converter (DAC) for converting digital audio signals into analog audio signals. The expansion card 29 has both an AD converter and a DA converter.

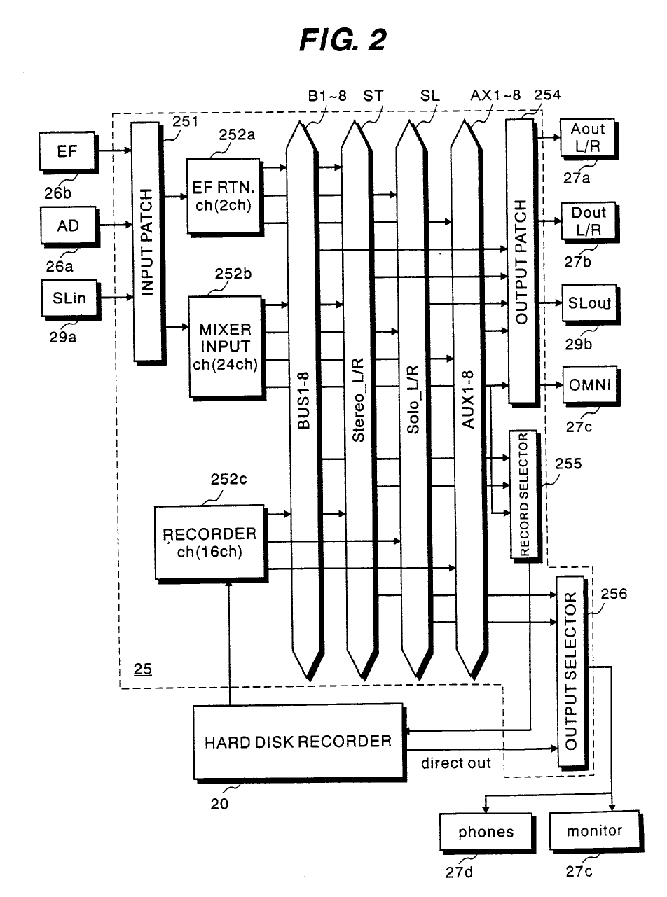

FIG. 2 is a block diagram showing the functions of DSP 25 shown in FIG. 1. Similar units to those shown in FIG. 1 are represented by using identical reference numerals. DSP 25 has an input patch 251, a 2-channel effect return (EF RTN) input 252a, a 24-channel mixer input 252b, a 16-channel recorder input 252c, eight buses B1 to B8, right and left two buses ST, right and left two SOLO buses SL, eight auxiliary (AUX) buses AX1 to AX8, an output patch 254, a record selector 255 and an output selector 256.

The input patch 251 allocates a plurality of audio signals input from an input AD 26a, an input EF 26b, an input SLin 29a and the like to the two channels of the effect return input 252a and some of input channels among twenty four channels of the mixer input 252b.

The input AD 26a inputs analog audio signals of first to eight channels via ADC. The input EF 26b inputs audio signals added with effects by an effector via AUX buses AX7 and AX8. The input SLin 29a inputs digital or analog audio signals from the expansion card 29 inserted into the expansion slot 28 shown in FIG. 1. Audio signals from the tone generator circuit 19 shown in FIG. 1 or digital audio signals may also be input.

The effect return input 252a performs various processes such as equalizing and volume adjustment for input audio signals and outputs the processed audio signals to the buses selected by the user among the buses B1 to B8, stereo buses ST, SOLO buses SL, and AUX buses AX1 to AX8.

The mixer input 252b performs various processes such as equalizing and volume adjustment for audio signals input to their channels and outputs the processed audio signals to the buses selected by the user among the buses B1 to B8, stereo buses ST, SOLO buses SL, and AUX buses AX1 to AX8, or directly to the output patch 254 and record selector 255.

The recorder input 252c allocates audio signals of the sixteen tracks of the HD recorder 20 to the corresponding first to sixteenth channels, performs various processes such as equalizing and volume adjustment for audio signals input to respective channels, and outputs the processed audio signals to the buses selected by the user among the buses B1 to B8, stereo buses ST, SOLO buses SL, and AUX buses AX1 to AX8.

The HD recorder 20 can directly output audio signals to the output selector 256 as will be later described, in addition to outputting audio signals to the recorder input 252c.

If audio signals are directly output to the output selector 256 from the HD recorder 20, it is possible to listen sounds of raw audio signals not subjected to various processes, because the audio signals do not pass through the buses B1 to B8, stereo buses ST, SOLO buses SL, and AUX buses AX1 to AX8.

The buses B1 to B8 mix audio signals input to the buses and output mixed audio signals to the output patch 254 and record selector 255.

The stereo buses ST mix audio signals of the right and left channels (Rch and Lch) input from the effect return input 252a, mixer input 252b and recorder input 252c, and output stereo audio signals to the output patch 254, record selector 255 and output selector 256.

The SOLO buses SL mix audio signals of the right and left channels (Rch and Lch) input from the effect return input 252a, mixer input 252b and recorder input 252c, and output stereo audio signals to the output patch 254 and output selector 256.

The AUX buses AX1 to AX8 mix audio signals of the eight channels input from the effect return input 252a, mixer input 252b and recorder input 252c, and output mixed audio signals to the output patch 254. The AUX buses AX7 and AX8 can be used as the effect send channels and can output audio signals to the input EF 26b.

The output patch 254 allocates audio signals input from the buses B1 to B8, stereo buses ST, SOLO buses SL and AUX buses AX1 to AX8, to any one of a stereo analog audio output 27a, a stereo digital audio signal output 27b, an output SLout 29b and an OMNI output 27c.

The output SLout 29b corresponds to digital or analog audio signals output from the expansion card 29 inserted into the expansion slot 28 shown in FIG. 1. The OMNI output 27c is a terminal having a DAC capable of outputting analog audio signals of four channels.

The record selector 255 can allocate monaural or stereo audio signals output from the buses B1 to B8, stereo buses ST and mixer input 252b, to each track of the HD recorder 20.

The output selector 256 outputs stereo audio signals output from the stereo buses ST and SOLO buses SL to a headphone output terminal 27d or a monitor output terminal 27c.

FIG. 3 is a schematic diagram showing an example of the front panel 2 of the digital mixer 1 with a reproducing/recording function shown in FIG. 1. The front panel 2 is provided with various displays and operation units.

An LCD display 23a is used for allocating each mixer channel and output bus for input audio signals by using a graphical user interface (GUI). The LCD display 23a is also used for various setting works such as setting of effect addition to audio signals. Manipulation through GUI is made by the operation unit such as a jog shuttle 46 and a cursor key 47.

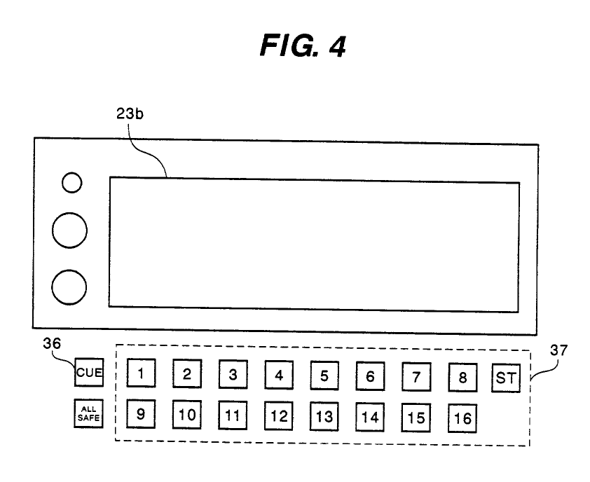

An FL display 23b displays a monitor level at each track of the HD recorder 20 (FIG. 1), a stereo bus level meter, a time counter and the like. As shown in FIG. 4, in the area under the FL display 23b, a CUE switch 36 and a plurality of track select switches 37 (for first to sixteenth tracks and stereo tracks) are disposed.

The CUE switch 36 is used for switching to a listening mode to be described later. The track select switch 37 is used for selecting a track to be listened in the listening mode, and for other purposes.

A SOLO switch 31 is used for switching between on/off of a SOLO mode to be later described. Channel select switches 32 are used for selecting a mixer channel. Information on a selected channel is displayed on the LCD display 23a and various settings can be made for audio signals of the selected channel. ON keys 42 are used for switching between on/off of an mixer input at each channel. In the SOLO mode, the ON key 42 is used for selecting a mixer channel or a track of the HD recorder 20, and for other purposes.

A PAN encoder 43 is a rotary encoder for PAN setting of a channel selected by the channel select switch 32. A fader 44 is used for setting the volume of each channel.

Number locate keys 45 are operated in order to enter a numerical value such as a listening start position. After a user operates this number locate keys 45, the listening start position is decided by using the jog shuttle 46, cursor keys 47 or the like.

A reproduction key 48 is an operation unit for instructing to reproduce audio signals recorded in the HD recorder 20. A stop key 49 is used for stopping the reproduction of audio signals.

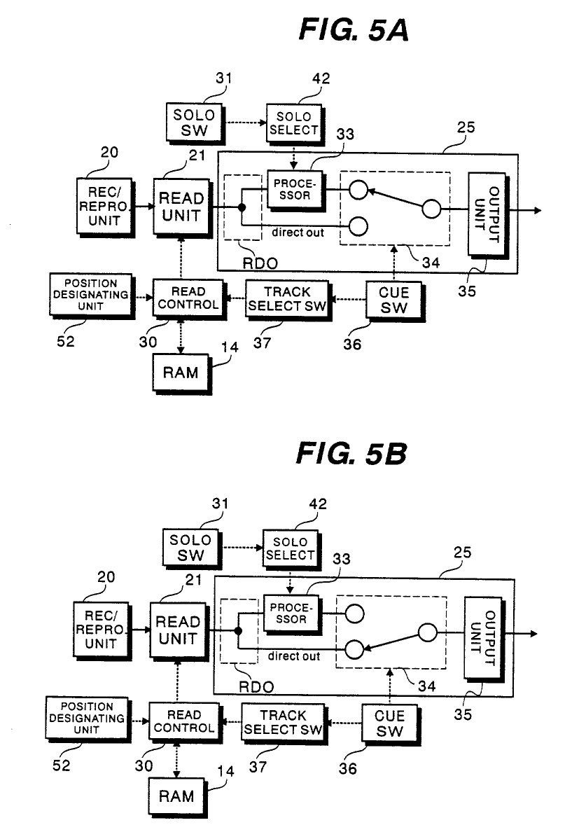

FIGS. 5A and 5B are schematic block diagrams illustrating the fundamental functions of the digital mixer 1 with a reproducing/recording function of this embodiment. The digital mixer 1 has at least a RAM 14, a recording/reproducing unit (HD recorder) 20, a read unit 21, a read control unit 30, a position designating unit 52, a DSP 25, a SOLO switch 31, a SOLO select switch (ON switch) 42, a CUE switch 36, and a track select switch 37. For the purposes of description convenience, the other structures are omitted.

FIG. 5A is a block diagram showing a connection state in a non-listening mode.

In the non-listening mode, the read unit 21 reads audio signals from a track of the recording/reproducing unit (HD recorder) 20 in response to an instruction from the read control unit 30.

The read audio signals are branched at a direct-out branch RDO and input to the processor 33. The audio signals input to the processor 33 are subjected to proper processes such as equalizing, volume adjustment and effect addition, and thereafter mixed and output to the output unit 35.

In the non-listening mode, the on/off of the SOLO mode can be switched by depressing the SOLO switch 31. In the SOLO Mode, the SOLO mode select switch 42 switches between the on/off of outputting audio signals from the read unit 21.

In the SOLO mode, by turning off the output of audio signals from the tracks other than the selected track to the output unit 35, it becomes possible to monitor only the selected track.

The SOLO mode selects one or more tracks to produce sounds. As different from the listening mode to be described later, audio signals added with various effects at the processor 33 are reproduced. Therefore, the switch to change to the connection of the SOLO mode is included in the processor 33.

FIG. 5B is a block diagram showing a connection state in the listening mode. As a user depresses the CUE switch 36, a DO switch 34 is turned over so that the state shown in FIG. 5A is changed to the state shown in FIG. 5B.

Thereafter, the user selects the desired track by using the track select switch 37. The number of tracks from which sounds are listened may be singular or plural.

After the user selects the track, the user may designate the position on the track from which the read unit 21 starts reading (starts listening), by operating the position designating unit 52. If audio signals are already reproduced and the start position is not designated, listening continues from the current position, whereas if audio signals are not being reproduced and the start position is not designated, listening starts from the head position of the selected track.

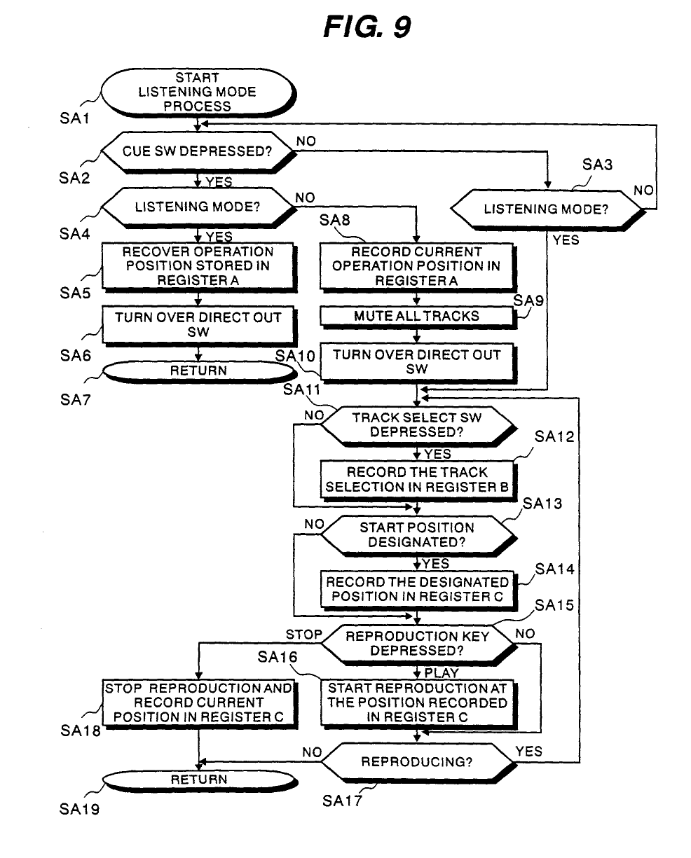

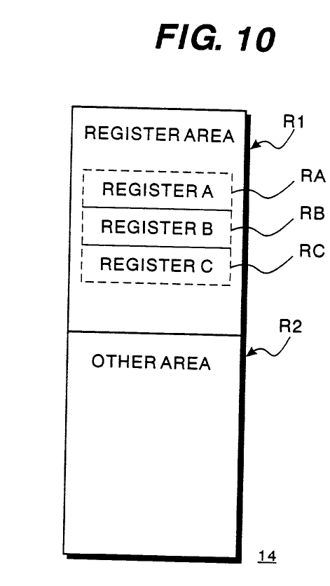

As the CUE switch 36, track select switch 37 and position designating unit 52 are operated, information on the read start position, selected track and the like is stored in registers A to C of a register area R1 (FIG. 10) of RAM 14, as will be later described with reference to FIG. 9.

In accordance with the information input upon operation of the CUE switch 36, track select switch 37 and position designating unit 52, the read control unit 30 notifies the read unit 21 of the track from which audio signals are read and the read start position.

In accordance with the notice from the read control unit 30, the read unit 21 reads audio signals from the recording/reproducing unit 20. Audio signals read from the recording/reproducing unit 20 are branched at the direct-out branch RDO and directly output to the output unit 35 via a line labeled as “direct out” in FIG. 5B.

As above, by turning over the DO switch 34, it becomes possible to output audio signals from the recording/reproducing unit 20 without involving the processor 33. Namely, a user can listen sounds of audio signals not subjected to volume adjustment and not added with other various effects.

Further, since sounds can be listened from the track selected by the track select switch 37, sounds can be listened without allocating each track of the recording/reproducing unit (HD recorder) 20 to the mixer input channel or recorder input channel.

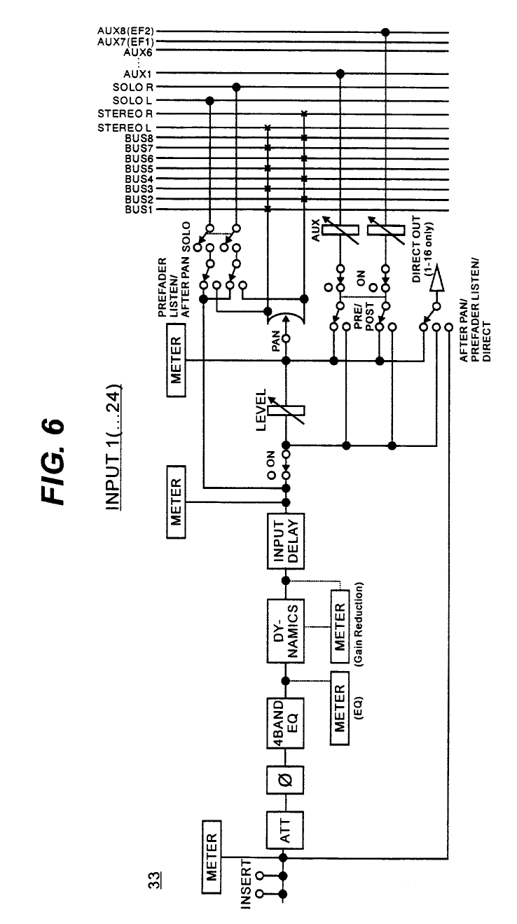

FIG. 6 is a connection diagram of the mixer input 252b, buses BI to B8, stereo buses ST, SOLO buses SL, AUX buses AX1 to AX8 and the like shown in FIG. 2. The connection diagram shown in FIG. 6 corresponds to the processor 33 shown in FIG. 5. Audio signals input to the processor 33 are subjected to various signal processing and then output to proper buses.

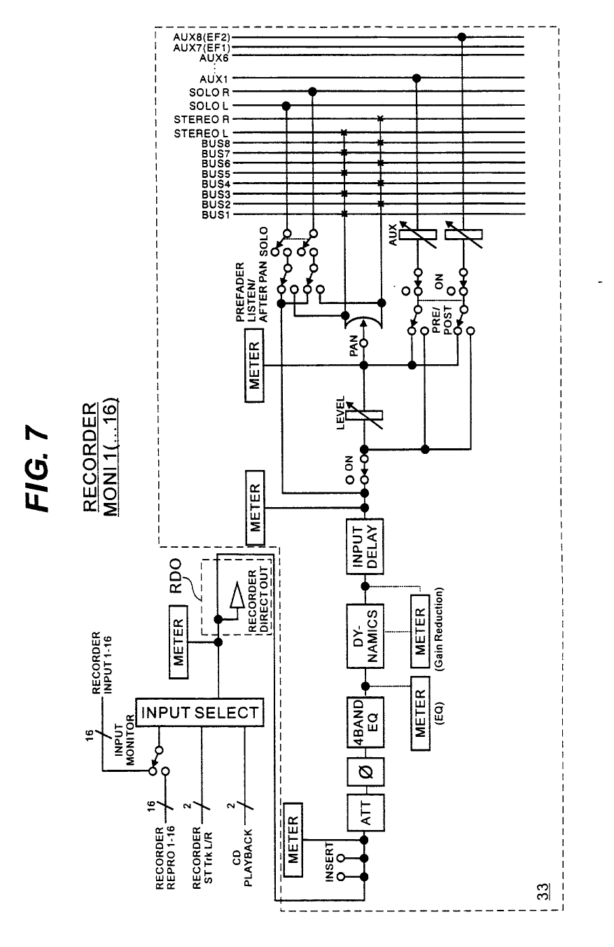

FIG. 7 is a connection diagram of the buses B1 to B8, stereo buses ST, SOLO buses SL, AUX buses AX1 to AX8 and the like shown in FIG. 2. A branch RDO labeled as “RECORDER DIRECT OUT” and surrounded by a broken line corresponds to the direct-out branch RDO shown in FIG. 5, and a circuit 33 surrounded by a broken line corresponds to the processor 33 shown in FIG. 5. Namely, an input from the HD recorder 20 is branched at the branch RDO as “RECORDER DIRECT OUT” before it is subjected to various processes at the processor 33.

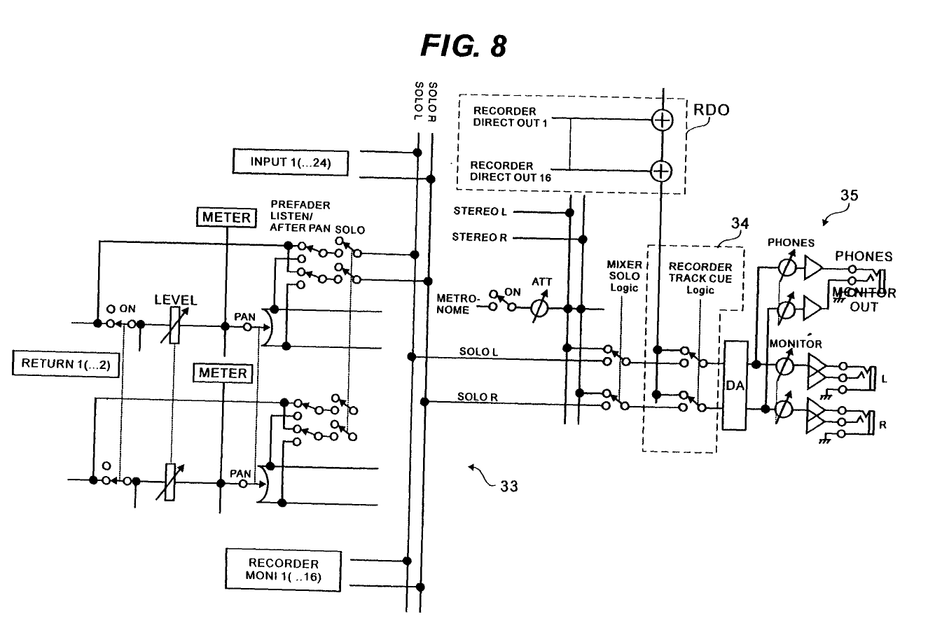

FIG. 8 is a connection diagram of the effect return input 252a, SOLO buses SL, output selector 256 and the like shown in FIG. 2. A branch RDO surrounded by a broken line is coupled to the branch RDO shown in FIG. 7. Namely, audio signals branched at the branch RDO shown in FIG. 7 are input to the branch RDO shown in FIG. 8. A switch 34 corresponds to the direct-out switch 34 shown in FIG. 5. By turning over this switch 34, the operation mode can enter the listening mode.

A circuit portion indicated by an arrow 35 at the right end in FIG. 8 corresponds to the output unit 35 shown in FIG. 5 and the headphone output terminal 27d and monitor output terminal 27c shown in FIG. 2. A circuit portion indicated by an arrow 33 on the central left side corresponds to the processor 33 shown in FIG. 5.

FIG. 9 is a flow chart illustrating a listening mode process to be executed by CPU 16 shown in FIG. 1. This process shown in the flow chart will be described with reference to FIGS. 1 and FIGS. 5A and 5B.

At Step SA1, the listening mode process starts to thereafter advance to the next Step SA2.

At Step SA2 it is checked whether the CUE switch 36 is depressed. If depressed, the flow advances to Step SA4 as indicated by a YES arrow, whereas if not, the flow advances to Step SA3 as indicated by a NO arrow.

At Step SA3 it is checked whether the present mode is the listening mode. If in the listening mode, the flow advances to Step SA11 as indicated by a YES arrow, whereas if not, the flow returns to Step SA2 as indicated by a NO arrow.

At Step SA4 it is checked whether the present mode is the listening mode. If in the listening mode, the flow advances to Step SA5 as indicated by a YES arrow at which the listening mode is released, whereas if not, the flow advances to Step SA8 as indicated by a NO arrow.

At Step SA5, in order to release the listening mode, the operation position at the time of listening mode start stored in the register A of RAM 14 (FIG. 10) is recovered. Namely, a time code stored at Step SA8 to be described later is read and the position of an audio signal in the HD recorder 20 indicated by the time code is recovered. Thereafter, the flow advances to Step SA6.

At Step SA6, the direct-out (DO) switch 34 is turned over to make an output from the HD recorder 20 direct toward DSP 25 (state shown in FIG. 5A). This turn-over operation releases the listening mode. Thereafter, the flow advances to the next Step SA7 to return to Step SAl.

At Step SA8, a time code representative of the current operation position (when the CUE switch 36 is depressed) is recorded in the registers A and C. Thereafter, the flow advances to Step SA9.

Since the position when the CUE switch 36 is depressed is stored in the register, the position at the listening mode start can be recovered easily after the listening mode is released.

At Step SA9, all tracks of the HD recorder 20 are muted. Thereafter, the flow advances to the next Step SA10.

At Step SA10, the DO switch 34 is turned over to change an output from the HD recorder 20 to a direct output (state shown in FIG. 5B). This turn-over confirms that the following operation is in the listening mode. Thereafter, the flow advances to the next Step SA11.

At Step SA11 it is checked whether the track select switch 37 is depressed. If depressed, the flow advances to the next Step SA12 as indicated by a YES arrow, whereas if not, the flow advances to Step SA13 as indicated by a NO arrow.

At Step SA12, information (such as an identifier for identifying a track) on the track selected at Step SA11 is recorded in the register B shown in FIG. 10. Thereafter, the flow advances to the next Step SA13. If the CUE switch 36 is depressed during the normal reproduction of the HD recorder 20, immediately after information on the selected track is recorded, sounds of the track may be reproduced.

At Step SA11, a plurality of tracks may be selected. In this case, information on the plurality of tracks is recorded at Step SA12.

At Step SA13 it is checked whether the listening start position is designated. If designated, the flow advances to the next Step SA14 as indicated by a YES arrow, whereas if not, the flow advances to Step SA15 as indicated by a NO arrow.

At Step SA14, the listening start position designated at Step SA13 is recorded in the register C shown in FIG. 10. In this case, if the time code representative of the start position is already recorded, this information is overwritten. Thereafter, the flow advances to the next Step SA15.

At Step SA15 it is checked whether the reproduction key 48, stop key 49 or the like is operated. If the reproduction key 48 is operated, the flow advances to the next Steps SA16 as indicated by a PLAY arrow. If the stop key 49 is operated, the flow advances to Step SA18 as indicated by a STOP arrow. If such operations are not performed, the flow advances to Step SA17 as indicated by a NO arrow.

At Step SA16, audio signals are read from the track of the HD recorder 20 recorded in the register B, and the read audio signals are reproduced. In this case, the audio signals are read from the start position recorded in the register C. Thereafter, the flow advances to the next Step SA17.

At Step SA17, it is checked whether the HD recorder 20 is reproducing audio signals. If reproducing, the flow returns to Step SA11 as indicated by a YES arrow, whereas if not, the flow advances to Step SA19 as indicated by a NO arrow.

At Step SA18, in order to stop the reproduction of audio signals, reading audio signals from the HD recorder 20 is stopped and the time code representative of the stop position is overwritten in the register C. Thereafter, the flow advances to the next Step SA19.

At Step SA19, the flow returns to Step SA1.

The above-described listening mode process may start during the reproduction by the HD recorder 20. In this case, after the track to be listened is selected at Step SA11, the track may be listened immediately starting from the position at the track select time.

Further, the position information to be recorded in the registers A and C is not limited to the time code, but other information may be recorded so long as it can indicate the read start position of an audio signal, such as an address of an audio signal recorded in the HD recorder 20.

In this embodiment, after the listening mode is stopped, the position at the listening start is automatically recovered. It is not necessarily required to automatically recover the position, but the listening start position may be recovered only when the user desires.

As described above, according to the embodiment of the invention, it is possible to listen sounds of audio signals recorded in the HD recorder, in a raw state without various effect addition.

Further, according to the embodiment of the invention, the position before the listening start can be recovered easily after the listening.

According to the embodiment, listening is possible without allocating each track of the HD recorder to the mixer input channel.

The embodiment may be realized by a commercial general purpose computer or the like installed with a computer program and the like realizing the functions of the embodiment.

In such a case, the computer program and the like realizing the embodiment functions may be stored in a computer readable storage medium such as a CD-ROM and a floppy disk and supplied to users.

If a general purpose computer or personal computer is connected to a communication network such as a LAN, the Internet and a telephone line, the computer program and various data may be supplied to the general purpose computer or personal computer via the communication network.

The present invention has been described in connection with the preferred embodiments. The invention is not limited only to the above embodiments. It is apparent that various modifications, improvements, combinations, and the like can be made by those skilled in the art.

What we claim are:

1. A recording/reproducing mixer, comprising:
a recording/reproducing device that records and/or reproduces a plurality of audio signals in/from a plurality of tracks;
a track selector that selects a track of said recording/reproducing device;
a reader that reads audio signals of the selected track of said recording/reproducing device;
a mixing device that mixes the read audio signals;
a designator that designates a listening mode; and
an output controller that outputs the read audio signals bypassing said mixing device when the listening mode is designated, and outputs the read audio signals via said mixing device when the listening mode is not designated.

2. A recording/reproducing mixer according to claim 1, further comprising a read starting position designator that designates a read starting position of audio signals,
wherein said reader starts reading from a position designated by said read starting position designator.

3. A recording/reproducing mixer according to claim 1, further comprising a position memory that memorizes a read starting position immediately before an operation mode is changed to the listening mode,
wherein said reader starts reading audio signals starting at the read starting position memorized in said position memory, after the listening mode is terminated.

4. A recording/reproducing mixing method for a mixer having a recording/reproducing device that records and reproduces a plurality of audio signals in/from a plurality of tracks, the method comprising the steps of:
(a) selecting a track of the recording/reproducing device;
(b) reading audio signals of the selected track of said recording/reproducing device;
(c) mixing the read audio signals;
(d) designating a listening mode; and
(e) outputting the read audio signals bypassing said mixing device when the listening mode is designated, and outputting the read audio signals via said mixing device when the listening mode is not designated.

5. A storage medium storing a program, which a computer executes to realize a recording/reproducing mixing process for a mixer having a recording/reproducing device that records and reproduces a plurality of audio signals in/from a plurality of tracks, the process comprising the instructions of:
(a) selecting a track of the recording/reproducing device;
(b) reading audio signals of the selected track of said recording/reproducing device;
(c) mixing the read audio signals;
(d) designating a listening mode; and
(e) outputting the read audio signals bypassing said mixing device when the listening mode is designated, and outputting the read audio signals via said mixing device when the listening mode is not designated.
